(19) United States
(12) Patent Application Publication
(10) Pub. No.: US 2026/0223878 A1
(43) Pub. Date: Aug. 6, 2026

(54) VEGAN CHEESE

(71) Applicant: Cargill, Incorporated, Wayzata, MN (US)

(72) Inventors: Christine Gianella ADDINGTON, Edgewater, CO (US); Regina DRAPER, Minnetonka, MN (US); Kimberly Jean HALEY, Maple Grove, MN (US); Haylie Sarah HATTON, Brooklyn Park, MN (US); John Phillip MILLER, Minneapolis, MN (US); Erin Marie RADERMACHER, Golden Valley, MN (US)

(73) Assignee: Cargill, Incorporated, Wayzata, MN (US)

(21) Appl. No.: 19/158,295

(22) PCT Filed: Mar. 8, 2024
(86) PCT No.: PCT/US2024/019017

§ 371 Date: Aug. 20, 2025

Related U.S. Application Data
(60) Provisional application No. 63/489,228, filed on Mar. 9, 2023.

(51) Int. Cl. A23C 20/02; A23P 30/10

(52) U.S. Cl. CPC A23C 20/025; A23P 30/10

(57) ABSTRACT

The invention relates to a dry blend for use in manufacturing vegan cheese, a vegan cheese made therefrom, and a method of producing the same. The invention further provides for the use of the dry blend to manufacture vegan cheese, a vegan cheese the dry blend, a food product comprising the vegan cheese, and a process for manufacturing vegan cheese comprising the dry blend.

### CROSS-REFERENCE TO RELATED APPLICATIONS

This application claims the benefit of U.S. Provisional Application No. 63/489,228, filed Mar. 9, 2023, which is incorporated by reference herein in its entirety.

### FIELD OF THE INVENTION

The invention relates to a dry blend for use in manufacturing vegan cheese, a vegan cheese made therefrom, and a method of producing the same.

### BACKGROUND OF THE INVENTION

An increasing number of people avoid dairy products, for example due to lactose intolerance, veganism, environmental concerns, or other health concerns or beliefs. There is therefore a growing demand from consumers for alternatives to traditional dairy cheese.

Alternative cheeses have been developed previously. For example, US2019059408 describes a cheese analogue product with modified starches selected from corn-derived modified starch, tapioca-derived modified starch, sago-derived modified starch, or combinations thereof. EP4048079 A1 describes a high protein analogue cheese having protein content greater than about 10% by weight. The analogue cheeses comprise pea starch and one more pulse protein isolates or pulse protein concentrates. WO2020210195 discloses plant-protein based analog dairy compositions comprising gum acacia.

However, there remains an unmet need for vegan cheese products which closely mimic the rheological and aesthetic properties of dairy cheese and have an acceptable flavour profile.

### BRIEF DESCRIPTION OF THE INVENTION

The invention provides a dry blend for use in manufacturing vegan cheese, the dry blend comprising a plant protein, a waxy starch, and a non-waxy starch.

The plant protein may be derived from a legume and is preferably pea protein. The dry blend optionally comprises from 4 wt % to 25 wt % plant protein.

The waxy starch may be derived from a cereal, tuber or root. Preferably the waxy starch comprises native and/or modified waxy starch. If modified, the waxy starch may be n-octenyl succinic anhydride modified waxy starch.

The non-waxy starch may be a native and/or modified non-waxy starch. If modified, the non-waxy starch may be an acid-thinned and/or acetylated non-waxy starch.

The dry blend optionally comprises from 50 wt % to 86 wt % waxy starch and from 14 wt % to 30 wt % non-waxy starch.

The ratio of waxy starch to non-waxy starch in the dry blend may be between 5:1 and 2:1.

The dry blend optionally further comprises lecithin.

In another aspect, the invention provides for the use of the dry blend disclosed herein to manufacture vegan cheese.

In a further aspect, the invention provides for a vegan cheese comprising a plant protein, a waxy starch, and a non-waxy starch.

In a further aspect, the invention provides for a food product comprising the vegan cheese disclosed herein.

In a further aspect, the invention provides for a process for manufacturing vegan cheese comprising: combining a dry blend with water and oil to obtain a mixture, the dry blend comprising a plant protein, a waxy starch, and a non-waxy starch; heating the mixture; pouring the heated mixture into a mold; and cooling the mixture to form a vegan cheese block.

The process optionally further comprises a pre-step of mixing dry ingredients to obtain a dry blend, the dry ingredients comprising a plant protein, a waxy starch, and a non-waxy starch.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a bar graph showing the peak tension force of melted vegan cheese made with waxy corn starch versus amylose-containing potato starch and amylose-containing pea starch.

FIG. 2 is a schematic illustrating how to interpret a texture profile analysis (TPA).

FIG. 3 is a bar graph showing adhesiveness of a block of vegan cheese made with waxy corn starch versus amylose-containing potato starch.

FIG. 4 is a bar graph showing the gelation capabilities of pea protein in combination with different salts.

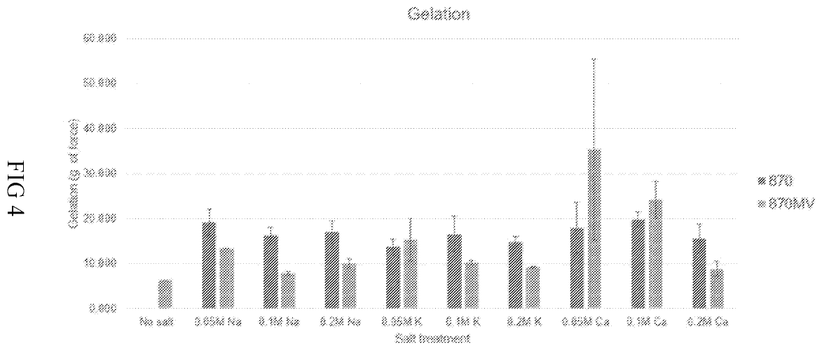

FIG. 5 is a line graph showing the adhesive force of melted vegan cheese vs distance.

### DETAILED DESCRIPTION OF THE INVENTION

Described herein is a dry blend for use in manufacturing vegan cheese, a method of making the same, and a vegan cheese produced therefrom.

As used herein, the term “dry blend” is a mixture of two or more dry ingredients, said mixture containing 12 wt % moisture or less, preferably 8-12 wt % moisture or less.

As used herein, the term “vegan cheese” is a cheese alternative that is a non-dairy food composition intended to mimic a dairy cheese.

### Dry Blend

The dry blend comprises or consists of a plant protein, a waxy starch, and a non-waxy starch.

The term “waxy starch” is used herein to refer to starch that is low in amylose, such as starch comprising 5 wt % or less of amylose, 3 wt % or less of amylose, 2 wt % or less of amylose, or no amylose. Preferably, the waxy starch comprises 5 wt % or less of amylose. The waxy starch may comprise from 0 to 5 wt % of amylose, or from 0 to 4 wt % of amylose, or from 0 to 3 wt % of amylose, or from 0 to 2 wt % of amylose, or from 0 to 1 wt % of amylose, or from 0.5 to 5 wt % of amylose. The term “non-waxy starch” is used herein to refer to starch that contains more than 5 wt % of amylose.

The ingredients in the dry blend individually impart particular rheological characteristics to vegan cheese made from the dry blend as described herein. Overall, the ingredients give the vegan cheese good texture, superior melt characteristics and mouthfeel, as well as desirable colour and flavour.

The plant protein is preferably derived from a legume. A legume is a plant in the family Fabaceae, or the fruit or seed of such a plant. A non-exhaustive list of suitable legumes includes peas, beans, soybeans, chickpeas, peanuts, lentils, lupins, mesquite, carob, tamarind, alfalfa, and clover. Preferably, the plant protein is pea protein. The plant protein advantageously provides desirable yellow colour and opacity to the vegan cheese, whilst also improving emulsification and oil release during melting, thereby improving mouthfeel. Plant protein also improved the chew and firmness (i.e. body) of the vegan cheese. It may also be desirable from a dietary perspective to have protein in vegan cheese in order to make it nutritionally closer to dairy cheese. “Plant protein” as used herein does not include protein that may be comprised within the waxy or non-waxy starch components of the dry blend.

The dry blend may comprise from 4 wt % to 25 wt % plant protein, preferably from 5 wt % to 20 wt %, more preferably from 6 wt % to 19 wt %, more preferably from 6 wt % to 15 wt %, most preferably from 6 wt % to 10 wt %. Preferably, the dry blend comprises less than 10% plant protein.

Without being bound by theory, waxy starch advantageously has a low amylose content, which improves the meltability of the vegan cheese. The waxy starch may be derived from any cereal, root, legume or tuber or combination thereof. Preferably the waxy starch is selected from the group consisting of waxy corn starch, waxy wheat starch, waxy rice starch, waxy tapioca starch, waxy potato starch, and combinations of any two or more thereof. More preferably, the waxy starch is derived from a cereal. Even more preferably the waxy starch is waxy corn starch.

Native and/or modified forms of waxy starch may be used in the dry blend. The waxy starch may be modified by any chemical and/or physical process known in the art. Preferably, the waxy starch is n-octenyl succinic anhydride modified waxy starch.

The waxy starch may comprise a blend of starches. Preferably, the waxy starch comprises native waxy starch, n-octenyl succinic anhydride modified waxy starch, or combinations thereof.

The dry blend may comprise from 50 wt % to 86 wt % of waxy starch. Preferably, the dry blend comprises from 55 wt % to 80 wt %, more preferably from 60 wt % to 80 wt %, even more preferably from 63 wt % to 80 wt %, most preferably from 60 wt % to 65 wt % of waxy starch.

Native and/or modified forms of non-waxy starch may be used in the dry blend. The non-waxy starch may be derived from any cereal, root, legume or tuber or combination thereof. Preferably the non-waxy starch is selected from the group consisting of potato starch, corn starch or pea starch, or combinations thereof. More preferably the non-waxy starch is a potato starch. The non-waxy starch may comprise a blend of starches.

The non-waxy starch may be modified by any chemical and/or physical process known in the art. The non-waxy starch is preferably an acid-thinned starch. Acid-thinning is a known process of partially hydrolysing native starch in the presence of an inorganic acid. Typically, acid-thinned starches are prepared by treating an aqueous starch slurry with an inorganic acid (typically HCl or H₂SO₄) for a suitable reaction time at a temperature lower than the gelatinization temperature of the starch. Acid thinning changes the amylose content and viscosity of the starch. The non-waxy starch may alternatively or additionally be modified by acetylation (“acetylated starch”). Acetylation is a known method that is typically carried out by esterification of native starch with acetic anhydride.

The non-waxy starch may comprise or consist of a starch that has been acid-thinned and acetylated. Preferably, the non-waxy starch is an acid-thinned and acetylated potato starch. C*Stretch 35326 (Cargill Incorporated) is a commercially available acid-thinned and acetylated potato starch. It was surprisingly found that including an acid-thinned and acetylated starch in the dry blend reduced the stickiness of the melted vegan cheese by suppressing melt and increasing gelling, thereby improving mouthfeel.

The non-waxy starch may be present in the form of internal legume fiber. Preferably, the internal legume fiber is internal pea fiber. Internal pea fiber is extracted from pea flour and comprises soluble and insoluble fibers, non-waxy starch (less than 60%) and protein (less than 15%).

The dry blend may comprise from 14 wt % to 30 wt % of non-waxy starch. Preferably, the dry blend comprises from 18 wt % to 27 wt %, more preferably from 20 wt % to 25 wt %, of non-waxy starch. Preferably, the non-waxy starch is present in an amount of less than 30 wt % of the dry blend, more preferably less than 27% of the dry blend, most preferably less than 25 wt % of the dry blend.

The ratio of waxy starch to non-waxy starch may be from 5:1 to 2:1, preferably from 3:1 to 2:1.

The waxy starch and/or the non-waxy starch may comprise a blend of starch(es) with non-starch ingredients.

The dry blend may also comprise Lecithin. It was unexpectedly found that, when used in combination with an acid-thinned and acetylated starch, lecithin contributes to the reduction in stickiness of the melted vegan cheese even more, whilst also increasing meltability of the vegan cheese. Preferred sources of lecithin are sunflower, soy and canola. The dry blend may comprise from 1 wt % to 5 wt % lecithin, preferably from 2 wt % to 3 wt % lecithin.

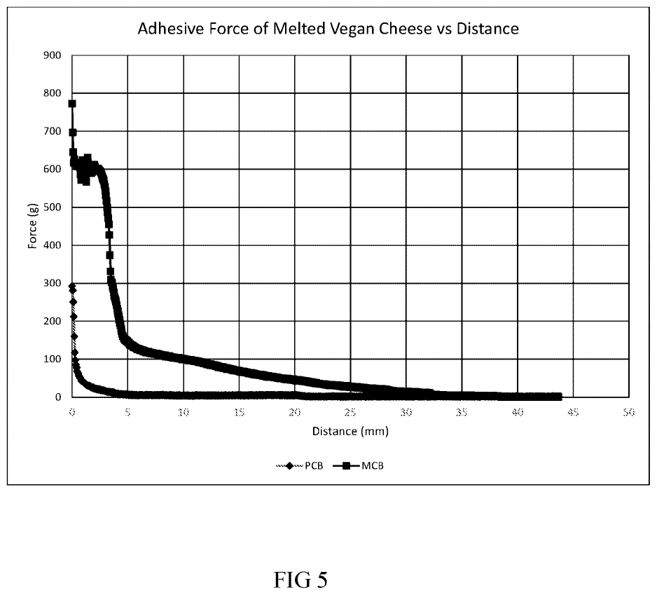

The dry blend may also comprise one or more salts, such as calcium chloride. A combination comprising plant protein (e.g., pea protein) and calcium chloride was surprisingly found to improve gelation, thereby reducing stickiness of the vegan cheese, compared to using other salts as shown in FIG. 5. Unexpectedly, calcium chloride was also found to improve emulsification stability of the vegan cheese immediately after cooking as it reduced oil separation at about 165° F. The improved emulsification stability in turn improved shreddability of the vegan cheese block once cooled and set. Alternatively, the dry blend does not comprise salts and the salts are added during the process of making the vegan cheese.

The dry blend may also comprise other ingredients, including but not limited to flavourings or seasonings (e.g. table salt), colourings, bulking agents, preservatives, emulsifiers, texturisers or thickening agents.

### Cheese

The dry blend described herein may be used to manufacture a vegan alternative for any dairy cheese type or variety. In one non-limiting example, the vegan cheese is a vegan alternative to mozzarella cheese.

Desirable properties for vegan cheese differ depending on the intended food application. For example, a vegan alternative to mozzarella cheese must have suitable stretch, melt, and firmness characteristics when heated so that it may be used as a pizza topping.

The vegan cheese comprises the dry blend described herein combined with other ingredients, including but not limited to water and oil.

The vegan cheese comprises from 17 wt % to 29 wt % of the dry blend, preferably from 20 wt % to 25 wt %, more preferably from 22 wt % to 24 wt %. The dry solids content of the vegan cheese is selected to optimize melt and stretch properties.

Any food grade oil may be used in the vegan cheese. Preferably, the oil is coconut oil. Coconut oil has several advantages. For example, it was unexpectedly found to provide improved firmness to the vegan cheese block, making it easier to shred, and also to improve mouthfeel. In addition, coconut oil is generally perceived as being more sustainable than some other oils making it more “label-friendly”.

The vegan cheese comprises from 19 wt % to 33 wt % oil, preferably from 22 wt % to 30 wt %, more preferably from 24 wt % to 28 wt %, or most preferably around 26 wt %. The oil content is selected to optimize melt and stretch whilst limiting drying out of the melted vegan cheese.

The vegan cheese comprises from 42 wt % to 56 wt % water, preferably from 49 wt % to 51 wt %.

The vegan cheese may comprise from 1 wt % to 6 wt % of plant protein, preferably from 1 wt % to 4 wt %, more preferably from 1 wt % to 3 wt %, most preferably around 1.5 wt %.

The vegan cheese may comprise from 12 wt % to 20 wt % waxy starch, preferably from 14 wt % to 19 wt %.

The vegan cheese may comprise from 3.5 wt % to 7 wt % non-waxy starch, preferably from 4.5 wt % to 6 wt %.

The vegan cheese may also comprise one or more salts, such as calcium chloride.

The vegan cheese may also comprise other ingredients, including but not limited to flavourings or seasonings (e.g. table salt), colourings, bulking agents, preservatives, emulsifiers, texturisers, acid(s), or thickening agents.

At room temperature or less, the vegan cheese may be in the form of a block, a ball, shredded (i.e. grated), sliced, or otherwise fragmented.

### Process of Vegan Cheese Manufacture

To make vegan cheese, the dry blend described herein is mixed with other ingredients including, but not limited to water and oil.

The process may involve a pre-step of obtaining the components of the dry blend and mixing them together using known mixing techniques until well incorporated to form the dry blend. The mixing is preferably carried out at room temperature.

Once the dry blend has been obtained, the dry blend may be combined with water and oil using any suitable equipment known in the art to form a mixture. Preferably, the water and oil are combined with the dry blend under agitation. The water and oil may be added simultaneously or sequentially.

The mixture is then heated, preferably to a temperature of from 65 to 90° C., for up to 10 minutes in total. The heating duration is preferably in a range from 3 to 8 minutes in total. The temperature may be ramped up in stages and held for some minutes at each stage. Preferably, the mixture is heated under agitation. More preferably, the mixture is heated under high shear.

The heated mixture may then be poured into a mould and refrigerated for 7 to 14 days, preferably 10 to 14 days. Surprisingly, it was found that when refrigerated for 10 to 14 days the vegan cheese has superior texture for shredding whilst also having good melting properties.

After refrigeration, the block can be shredded (i.e. grated) or sliced as required.

### EXAMPLES

The invention will now be described with reference to the following non-limiting examples.

### Example 1: Process for Making Mozzarella-Style Vegan Cheese

1. Create dry blend by mixing dry ingredients at room temperature in a bowl with a wooden spoon until well incorporated.
2. Put room temperature water in pilot cheese cooker (Blentech CC-0010) and begin agitation.
3. Add dry blend to water. Start with agitation speed at 1-3 and increase as needed until agitation speed is 9.
4. Add acid to Blentech. Blend for 5-10 min.
5. Slowly add oil to Blentech over a period of 5-10 min. Add about ¼th cup at a time. Blend for 5 min once all oil has been added.
6. Begin heating using indirect steam whilst agitating at speed setting 9 Turn steam off once temperature reached 150° F.
7. Once entire mass has reached 150° F., begin steam again. Heat until temperature reaches 175° F. Hold for 2 min.
8. Stop steam and empty sample into pan to form a (3.5 kg) block in the fridge.
9. Set the block in the fridge for 5-10 days.
10. Grate the cheese (optional).

### Example 2: Recipe Development and Sensory Testing

Grated vegan cheese samples were prepared using the process of example 1 in accordance with recipes 1 to 13 in Table 1. 50 g of each cheese was then scattered on a pizza base with 30 g of tomato sauce. The pizzas were then baked in an oven at 425° F. for 8 minutes. The cooked pizzas were tasted by a sensory panel and the performance of each vegan cheese sample was assessed. A ranking of from 1 to 10 was given to each sample (with 10 being the most preferred and 1 being the least preferred).

TABLE 1
Vegan cheese recipes

| | | | |
|---|---|---|---|
| Ingredient | | Sensory panel | Sensory panel |
| Description | % WT | Ranking | comments |

Recipe 1: Base recipe

| | | | |
|---|---|---|---|
| Water | 49.34 | 7 | Good melt |
| Coconut oil | 26.00 | | properties, |
| C*Gel 04230 | 17.25 | | unpleasant sticky |
| (native waxy corn | | | mouthfeel. |
| starch) | | | |
| C*EmTex12688 | 5.75 | | |
| (pregel nOSA waxy | | | |
| corn starch) | | | |
| Sodium chloride | 1.50 | | |
| Vitex AAC 53 N¹ | 0.16 | | |
| (acid blend, liquid) | | | |

Recipe 2: Modified Potato starch

| | | | |
|---|---|---|---|
| Water | 53.69 | 4.5 | Decreased sticky |
| Coconut oil | 26.00 | | mouthfeel, but |
| C*stretch 35326 | 12.92 | | prevented melt. |
| (acid-thinned, | | | |
| acetylated potato | | | |
| starch) | | | |
| C*EmTex12688 | 5.74 | | |
| (pregel nOSA waxy | | | |
| corn starch) | | | |
| Sodium chloride | 1.50 | | |
| Vitex AAC 53 N¹ | 0.16 | | |
| (acid blend, liquid) | | | |

Recipe 3: Lecithin

| | | | |
|---|---|---|---|
| Water | 47.34 | 3 | Decreased sticky |
| Coconut oil | 26.00 | | mouthfeel, but |
| C*Gel 04230 | 17.22 | | increased melt and |
| (native waxy corn | | | oiling out. |
| starch) | | | Transparent and |
| C*EmTex12688 | 5.74 | | has a slippery |
| (pregel nOSA waxy | | | texture |
| corn starch) | | | |
| Emulpur SF | 2.00 | | |
| (lecithin) | | | |
| Sodium chloride | 1.50 | | |
| Vitex AAC 53 N¹ | 0.20 | | |
| (acid blend, liquid) | | | |

Recipe 4: Pea protein

| | | | |
|---|---|---|---|
| Water | 44.03 | 6 | Decreases sticky |
| Coconut oil | 26.00 | | mouthfeel, |
| C*Gel 04230 | 17.22 | | increases oil |
| (native waxy corn | | | release (better |
| starch) | | | emulisifcation) |
| C*EmTex12688 | 5.74 | | and improved |
| (pregel nOSA waxy | | | colour closer to |
| corn starch) | | | dairy cheese. |
| Puris 870 MV (pea | 4.50 | | |
| protein) | | | |
| Calcium Chloride | 0.55 | | |
| Sodium chloride | 1.50 | | |
| Vitex AAC 53 N¹ | 0.46 | | |
| (acid blend, liquid) | | | |

Recipe 5: Tapioca starch

| | | | |
|---|---|---|---|
| Water | 49.34 | 5 | Good melting |
| Coconut oil | 26.00 | | characteristics |
| CreamGel 70001 | 17.22 | | |
| (native tapioca | | | |
| starch) | | | |
| C*EmTex12688 | 5.74 | | |
| (pregel nOSA waxy | | | |
| corn starch) | | | |
| Sodium chloride | 1.50 | | |
| Vitex AAC 53 N¹ | 0.20 | | |
| (acid blend, liquid) | | | |

Recipe 6: Potato starch

| | | | |
|---|---|---|---|
| Water | 49.34 | 4 | Some melting |
| Coconut oil | 26.00 | | occurred with |
| C*Gel LM 30012 | 17.22 | | some dry shreds |
| (low moisture native | | | on top |
| potato starch) | | | |
| C*EmTex12688 | 5.74 | | |
| (pregel nOSA waxy | | | |
| corn starch) | | | |
| Sodium chloride | 1.50 | | |
| Vitex AAC 53 N¹ | 0.20 | | |
| (acid blend, liquid) | | | |

Recipe 7: Dent corn starch

| | | | |
|---|---|---|---|
| Water | 49.34 | 3 | Poor melt |
| Coconut oil | 26.00 | | characteristics |
| Cargill Gel 03420 | 17.22 | | |
| (native dent corn | | | |
| starch) | | | |
| C*EmTex12688 | 5.74 | | |
| (pregel nOSA waxy | | | |
| corn starch) | | | |
| Sodium chloride | 1.50 | | |
| Vitex AAC 53 N¹ | 0.20 | | |
| (acid blend, liquid) | | | |

Recipe 8: Pea starch

| | | | |
|---|---|---|---|
| Water | 49.34 | 1 | Poor melt |
| Coconut oil | 26.00 | | characteristics |
| Cosucra Pea starch | 17.22 | | |
| C*EmTex12688 | 5.74 | | |
| (pregel nOSA waxy | | | |
| corn starch) | | | |
| Sodium chloride | 1.50 | | |
| Vitex AAC 53 N¹ | 0.20 | | |
| (acid blend, liquid) | | | |

Recipe 9: With pea protein

| | | | |
|---|---|---|---|
| Water | 49.43 | 9 | Decreased melt |
| Coconut oil | 26.00 | | and increased |
| C*Gel 04230 | 9.00 | | opacity, chew, and |
| (native waxy corn | | | firmness compared |
| starch) | | | to without pea |
| C*stretch 35326 | 5.46 | | protein (recipe |
| (acid-thinned, | | | 11). |
| acetylated potato | | | |
| starch) | | | |
| C*EmTex12688 | 5.74 | | |
| (pregel nOSA waxy | | | |
| corn starch) | | | |
| Calcium chloride | 0.55 | | |
| Puris 870 MV | 1.50 | | |
| Sodium chloride | 1.50 | | |
| Lecithin | 0.50 | | |
| Vitex AAC 53 N¹ | 0.32 | | |
| (acid blend, liquid) | | | |

Recipe 10: Without pea protein

| | | | |
|---|---|---|---|
| Water | 49.61 | 7.5 | Good melt |
| Coconut oil | 26.00 | | characteristics, |
| C*Gel 04230 | 9.00 | | thin texture, |
| (native waxy corn | | | transparent in |
| starch) | | | spots |
| C*stretch 35326 | 5.46 | | |
| (acid-thinned, | | | |
| acetylated potato | | | |
| starch) | | | |
| C*EmTex12688 | 7.79 | | |
| (pregel nOSA waxy | | | |
| corn starch) | | | |
| Sodium chloride | 1.50 | | |
| Lecithin | 0.50 | | |
| Vitex AAC 53 N¹ | 0.14 | | |
| (acid blend, liquid) | | | |

Recipe 11: With lecithin

| | | | |
|---|---|---|---|
| Water | 48.87 | 8 | Decreases |
| Coconut oil | 26.00 | | stickiness, |
| Lecithin | 0.50 | | increased oil |
| C*Gel 04230 | 10.79 | | release, improves |
| (native waxy corn | | | melt, decreases |
| starch) | | | opacity compared |
| C*stretch 35326 | 6.46 | | to without lecithin |
| (acid-thinned, | | | (recipe 13). |
| acetylated potato | | | |
| starch) | | | |
| C*EmTex12688 | 5.74 | | |
| (pregel nOSA waxy | | | |
| corn starch) | | | |
| Sodium chloride | 1.50 | | |
| Vitex AAC 53 N¹ | 0.14 | | |
| (acid blend, liquid) | | | |

Recipe 12: Without Lecithin

| | | | |
|---|---|---|---|
| Water | 49.34 | 5 | Some melt |
| Coconut oil | 26.00 | | characteristics |
| C*Gel 04230 | 10.79 | | with non-melted |
| (native waxy corn | | | shreds on top, |
| starch) | | | opaque, high shred |
| C*stretch 35326 | 6.46 | | identity |
| (acid-thinned, | | | |
| acetylated potato | | | |
| starch) | | | |
| C*EmTex12688 | 5.75 | | |
| (pregel nOSA waxy | | | |
| corn starch) | | | |
| Sodium chloride | 1.50 | | |
| Vitex AAC 53 N¹ | 0.16 | | |
| (acid blend, liquid) | | | |

Recipe 13: Combination

| | | | |
|---|---|---|---|
| Water | 48.58 | 8 | Good melt, low |
| Coconut oil | 26.00 | | stickiness, good |
| Puris 870 MV | 3.00 | | body and chew, |
| Calcium chloride | 0.55 | | good colour, good |
| C*Gel 04230 | 8.47 | | opacity. |
| (native waxy corn | | | Some off-flavor |
| starch) | | | and gritty texture |
| C*stretch 35326 | 5.23 | | compared to |
| (acid-thinned, | | | Recipe 10 |
| acetylated potato | | | |
| starch) | | | |
| C*EmTex12688 | 5.75 | | |
| (pregel nOSA waxy | | | |
| corn starch) | | | |
| Lecithin | 0.50 | | |
| Sodium Chloride | 1.5 | | |
| Vitex AAC 53 N¹ | 0.42 | | |
| (acid blend, liquid) | | | |

¹Vitex AAC 53 N is an acid blend comprising citric acid and lactic acid.

### Example 3: Dry Blend

A dry blend was prepared by mixing the dry ingredients shown in table 2 using routine methods until well incorporated.

TABLE 2
Dry blend recipe 1

| Ingredient | | |
|---|---|---|
| Description | % WT | Grams |
| Emulpur SF | 2.25 | 17.48 |
| (Sunflower lecithin) | | |
| C*Gel 04230 (native | 40.54 | 315.00 |
| waxy corn starch) | | |
| C*Stretch 35326 (acid | 24.59 | 191.06 |
| thinned, acetylated | | |
| potato starch) | | |
| C*EmTex 12688 | 25.86 | 200.93 |
| (pregel nOSA waxy | | |
| corn starch) | | |
| Puris 870MV (pea | 6.76 | 52.53 |
| protein) | | |
| Total | 100.00% | 777.00 |

### Example 4: Dry Blend

A dry blend with calcium chloride was prepared by mixing the dry ingredients shown in table 3 using routine methods until well incorporated.

TABLE 3
Dry blend recipe 2

| Ingredient | | |
|---|---|---|
| Description | % WT | Grams |
| Emulpur SF | 2.06 | 20.00 |
| (Sunflower lecithin) | | |
| C*Gel 04230 (native | 37.12 | 360.07 |
| waxy corn starch) | | |
| C*Stretch 35326 (acid | 22.52 | 218.44 |
| thinned, acetylated | | |
| potato starch) | | |
| C*EmTex 12688 | 23.67 | 229.65 |
| (pregel nOSA waxy | | |
| corn starch) | | |
| Puris 870MV (pea | 6.19 | 60.01 |
| protein) | | |
| Sodium Chloride | 6.19 | 60.01 |
| Calcium chloride | 2.25 | 21.81 |
| Total | 100.00% | 970.00 |

### Example 5: Vegan Cheese

A vegan cheese was prepared using the process of example 1 and the dry blend of example 3.

TABLE 4
Vegan cheese recipe 1
Vegan Cheese Recipe:

| Ingredient Description | % WT | Grams |
|---|---|---|
| Water | 50.05% | 1751.75 |
| Coconut Oil | 26.00% | 910.00 |
| Dry blend | 22.2% | 777.00 |
| Sodium Chloride | 1.50% | 52.5 |
| Vitex AAC 53 N | 0.25% | 8.75 |
| (Lactic Acid, Water, | | |
| Citric Acid, Natural | | |
| Flavors; Dilution = 77- | | |
| 85 ml 0.1N NaOH, | | |
| liquid) | | |
| Total | 100% | 3500.00 |

### Example 6: Vegan Cheese

A vegan cheese was prepared using the process of example 1 and the dry blend of example 4.

TABLE 5
Vegan cheese recipe 2
Vegan Cheese Recipe:

| Ingredient Description | % WT | Grams |
|---|---|---|
| Water | 49.50 | 1980.00 |
| Coconut Oil | 26.00 | 1040.00 |
| Dry blend | 24.25 | 970.00 |
| Vitex AAC 53 N | 0.25 | 10.00 |
| (Lactic Acid, Water, | | |
| Citric Acid, Natural | | |
| Flavors; Dilution = 77- | | |
| 85 ml 0.1N NaOH, | | |
| liquid) | | |
| Total | 100.00 | 4000.00 |

### Example 7: Amylose Content and Melt Characteristics

Vegan cheese samples were prepared according to recipes 1, 6 and 8 in table 1. The effect of amylose on melt characteristics was tested by comparing peak tension force. Peak tension force was measured by the following method:
1. Shred the vegan cheese block using a grater with 0.5 cm holes. Shreds should be 4-5 cm long.
2. Place a 3 cm long hose clamp onto a 13 in×9 in baking pan. This is the cheese stretching fixture. Place 2 g of vegan cheese shreds perpendicularly across the hose clamp.
3. Connect a small (4 cm) clamp probe attachment and a 5 kg cell block to a Texture Analyzer HD Plus instrument. Calibrate the probe height and set the return height to 21 mm.
4. Melt the cheese by putting the pan in a 220° C. Venticell oven for 1 minute.
5. Connect the cheese stretching fixture to a Texture Analyzer HD Plus instrument. Place weights over the ends of the melted cheese.
   6. Run a tension test with a test speed and post-test speed of 10 mm/see to a final distance of 40 mm.
7. Record the peak tension force (g) that occurred during the test.

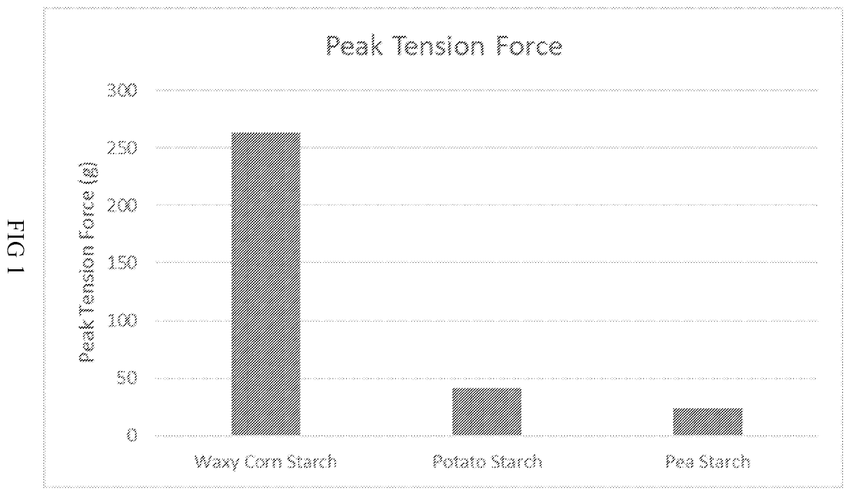

As shown in FIG. 1 peak tension force was higher when low-amylose waxy starch was used (recipe 1) compared to high-amylose potato starch (recipe 6) or pea starch (recipe 8). Generally, samples which did not melt well (visual observation) were found to have a low peak tension force.

### Example 8: Amylose Content and Adhesion

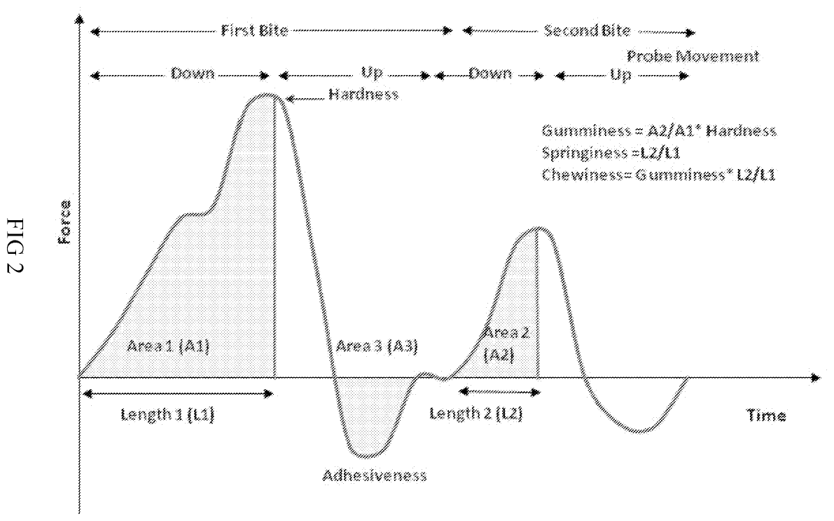

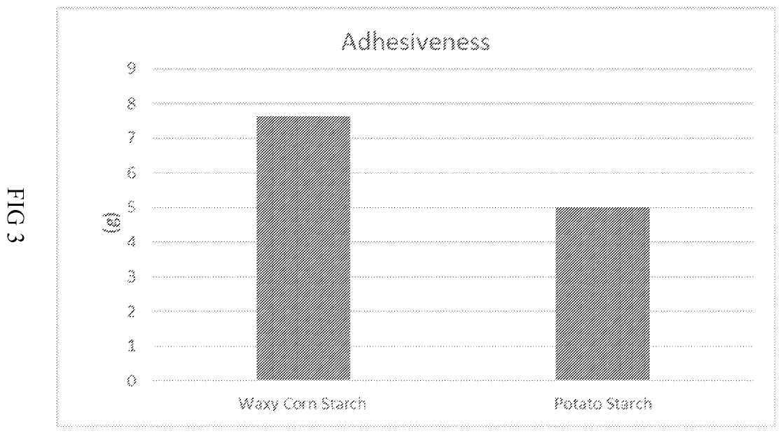

Vegan cheese samples were prepared according to recipes 1 (waxy starch) and 6 (amylose-containing potato starch) in table 1. The effect of amylose on adhesion (stickiness) was tested by comparing texture profile analyses. Texture profile analysis (TPA) is a double compression test that is meant to mimic chewing. The area of negative force between compressions represents adhesiveness as shown in FIG. 2. The results in FIG. 3 demonstrate that adding amylose decreased stickiness of the cold-set block sample. The stickiness of the cold-set block affects the shred ability. Adhesiveness was measured by:
1. Using a wire cheese cutter, cut 1 cm cubes from a vegan cheese block.
2. Connect a 2.5 cm flat probe to a Texture Analyzer HD Plus instrument. Calibrate the probe height and set the return distance to 21 mm.
3. Run a Texture Profile Analysis (TPA) measurement with a pre-test speed and test speed of 2 mm/sec, a post test speed of 5 mm/sec, a strain target mode to 30%, a time of 0.5 sec, and a trigger force of 5 g.
4. The instrument will calculate the adhesiveness as area of negative force between the two compressions.

### Example 9: Colour Analysis

Vegan cheese samples were prepared in accordance with recipes 1 and 9 in table 1. A HunterLab LabScan XE colorimeter analysis was performed using the following method. The results are shown in table 6.
1. Using a wire cheese cutter, cut a 3.5 cm cube from a vegan cheese block.
2. Place the block in a HunterLab glass analysis cup.
3. Using a 2 cm orifice plate, standardize the colorimeter with a black and white plate.
4. Place the sample cup on the instrument, ensuring the block fulling covers the orifice. Place the black light-blocking cup over the sample cup and start the test using D65 illuminant at a 10° angle.

Note: L-value represents the darkness to lightness (1 to 100) of the sample. The a-value represents the greenness to redness (−128 to 127) of the sample. The b-value represents the blueness to yellowness (−128 to 127) of the sample.

TABLE 6
Colour analysis

| Sample | L | a | b |
|---|---|---|---|
| Recipe 1 | 87.16 | −1.16 | 4.61 |
| Recipe 9 | 86.08 | −0.15 | 9.02 |

### Example 10: Stickiness

Vegan cheese samples were prepared in accordance with recipes 1 and 9 in table 1. Stickiness of the samples was assessed by the below method. The results, shown in FIG. 5, show that adding amylose, lecithin, and pea protein decrease stickiness of the melted sample shreds.
1. Shred the vegan cheese block using a grater with 0.5 cm holes. Shreds should be 4-5 cm long.
2. Place 2 g of vegan cheese shreds on a 13 in×9 in baking pan.
3. Connect a checker textured circular probe (10 cm diameter) attachment and a 5 kg cell block to a Texture Analyzer HD Plus instrument. Place the matching check textured base below the probe and calibrate the probe height. Set the return height to 10 mm.
4. Melt the cheese by putting the pan in a 220° C. Venticell oven for 1 minute.
5. Use a spatula to remove the cheese from the pan and place it in the center of the textured base.
6. Set the trigger force to 5 g, the applied force to 500 g, and the contact time to 10 seconds. Run an adhesive test with a pre-test and test speed of 0.5 mm/sec and a post-test speed of 10 mm/sec to a final distance of 40 mm.

When used in this specification and claims, the terms “comprises” and “comprising” and variations thereof mean that the specified features, steps or integers are included. The terms are not to be interpreted to exclude the presence of other features, steps or components. Additionally, the phrase “consisting essentially of” will be understood to include those elements specifically recited and those additionally elements that do not materially affect the basic and novel characteristics of the invention. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter form the genus, regardless of whether or not the excised material is specifically.

Throughout this document, particularly in terms of providing a written description, all values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. Any listed range can be easily recognized as sufficiently describing and enabling the same range being broken down into at least equal halves, thirds, quarters, fifths, tenths, etc. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure and are not meant to be limiting in any fashion.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. In the event of inconsistent usages between this document and those documents so incorporated by reference, the usage in the incorporated reference should be considered supplementary to that of this document; for irreconcilable inconsistencies, the usage in this document controls.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A dry blend for use in manufacturing vegan cheese, the dry blend comprising a plant protein, a waxy starch, and a non-waxy starch.

2. The dry blend of claim 1, wherein the waxy starch has an amylose content of 5 wt % or less.

3. The dry blend of claim 1, wherein the plant protein is derived from a legume.

4. The dry blend of claim 1, wherein the plant protein is pea protein.

5. The dry blend of claim 1, comprising from 4 wt % to 25 wt % plant protein.

6. The dry blend of claim 1, wherein the waxy starch is derived from a cereal, tuber or root.

7. The dry blend of claim 1, wherein the waxy starch comprises a native and/or modified waxy starch.

8. The dry blend of claim 7, wherein the modified waxy starch is n-octenyl succinic anhydride modified waxy starch.

9. The dry blend of claim 1, wherein the non-waxy starch comprises a modified and/or native non-waxy starch.

10. The dry blend of claim 9, wherein the modified non-waxy starch is an acid-thinned and/or acetylated non-waxy starch.

11. The dry blend of claim 1, comprising from 50 wt % to 86 wt % waxy starch and from 14 wt % to 30 wt % non-waxy starch.

12. The dry blend of claim 1, wherein the ratio of waxy starch to non-waxy starch is between 5:1 and 2:1.

13. The dry blend of claim 1, further comprising lecithin.

14. (canceled)

15. A vegan cheese comprising a plant protein, a waxy starch, and a non-waxy starch.

16. A vegan cheese according to claim 15, further comprising calcium chloride.

17. A food product comprising the vegan cheese of claim 15.

18. A process for manufacturing vegan cheese comprising:
i. combining a dry blend with water and oil to obtain a mixture, the dry blend comprising a plant protein, a waxy starch, and a non-waxy starch;
ii. heating the mixture;
iii. pouring the heated mixture into a mold; and
iv. cooling the mixture to form a vegan cheese block.

19. The process of claim 18 further comprising a pre-step of mixing dry ingredients to obtain a dry blend, the dry ingredients comprising a plant protein, a waxy starch, and a non-waxy starch.
